(19) United States
(12) Patent Application Publication
(10) Pub. No.: US 2002/0156971 A1
(43) Pub. Date: Oct. 24, 2002

(54) Method, apparatus, and program for providing hybrid disk mirroring and striping

(75) Inventors: Jeffrey Allen Jones, Round Rock, TX (US); Douglas Scott Rothert, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/838,168

(22) Filed: Apr. 19, 2001

(51) Int. Cl. G06F 12/16

(52) U.S. Cl. 711/114

(57) ABSTRACT

Hard disk drives are used to mirror and stripe data. At the time of a write, a hard disk controller writes a first stripe to a first hard disk and allocate an appropriate amount of space on a second hard disk to mirror the stripe. Simultaneously, a second stripe may be written to the second hard disk and an appropriate amount of space may be allocated on the first hard disk to mirror the second stripe. Information about which stripes have and have not been mirrored is stored in memory. At a later time, such as during idle disk time, a controller or file system may synchronize the data between drives by copying the corresponding stripe into the pre-allocated space. During idle disk time, the controller or file system may also validate stripes to identify corrupted data. A user may specify whether to mirror data at the time of a write and whether to validate data at the time of a read. Therefore, the user may decide between speed and reliability for both reads and writes individually.

### BACKGROUND OF THE INVENTION

1. Technical Field

The present invention relates to data processing and, in particular, to a redundant array of independent disks. Still more particularly, the present invention provides a method, apparatus, and program for developing a hybrid of striping and mirroring in a disk subsystem without increasing the number of disk drives.

2. Description of Related Art

Redundant Array of Independent Disks (RAID) is a disk subsystem that increases performance and provides fault tolerance. RAID requires a set of two or more hard disks and a specialized disk controller that contains the RAID functionality. Developed initially for servers and stand-alone disk storage systems, RAID is increasingly becoming available in desktop personal computers primarily for fault tolerance. RAID may also be implemented using software only, but with less performance, especially when rebuilding data after a failure.

Disk striping is a level of RAID that improves performance by interleaving bytes or groups of bytes across multiple drives, so more than one disk is reading and writing simultaneously. Data is interleaved by bytes or by sectors across the drives. For example, with four drives and a controller designed to overlap reads and writes, four sectors could be read in the same time it normally takes to read one sector. Disk striping is referred to as RAID level 0 (zero) or RAID 0. Disk striping does not inherently provide fault tolerance or error checking. However, striping may be used in conjunction with other methods for fault tolerance.

Fault tolerance may be achieved by mirroring. Mirroring involves duplication of the data on two drives. Data may be written on two separate disks within the same system. A failed drive may be replaced with a new drive and a RAID controller can automatically rebuild the lost data. Disk mirroring is referred to as RAID level 1 (one) or RAID 1.

Using disk striping (RAID 0) and disk mirroring (RAID 1) in conjunction may provide the performance of striping and the reliability of mirroring. The combination of RAID 0 and RAID 1 is referred to as RAID 0/1. However, using RAID 0 and RAID 1 in conjunction requires at least four disk drives, two drives for striping and two more drives to mirror the stripes. Most small offices and home offices use general purpose personal computers. These computers typically have a maximum of two disk drives due to size and expense. Thus, one must decide between striping and mirroring when implementing RAID on a general purpose computer.

Therefore, it would be advantageous to develop a hybrid of striping and mirroring in a disk subsystem without increasing the number of required disk drives.

### SUMMARY OF THE INVENTION

The present invention uses hard disk drives to mirror and stripe data. At the time of a write, a hard disk controller may write a first stripe to a first hard disk and allocate an appropriate amount of space on a second hard disk to mirror the stripe. Simultaneously, a second stripe may be written to the second hard disk and an appropriate amount of space may be allocated on the first hard disk to mirror the second stripe. Information about which stripes have and have not been mirrored is stored in memory. At a later time, such as during idle disk time, a controller or file system may synchronize the data between drives by copying the corresponding stripe into the pre-allocated space. During idle disk time, the controller or file system may also validate stripes to identify corrupted data.

Thus, one may realize the increased performance of striping and the increased reliability of mirroring without requiring four or more hard disk drives. Alternatively, a user may specify whether to mirror data at the time of a write and whether to validate data at the time of a read. Therefore, the user may decide between speed and reliability for both reads and writes.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIGS. 3A-3C are block diagrams illustrating prior art techniques for striping and mirroring data;

FIG. 4 is a block diagram illustrating data striping and data mirroring used in conjunction in accordance with a preferred embodiment of the present invention; and

FIG. 5 is a flowchart illustrating the operation of a hard disk controller or file system in accordance with a preferred embodiment of the present invention.

### DETAILED DESCRIPTION OF THE PREFERRED EMBODIMENT

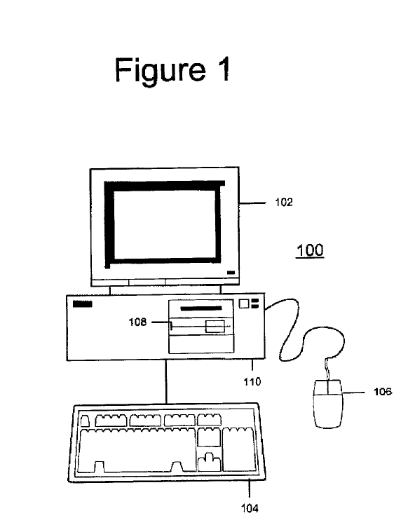

With reference now to the figures and in particular with reference to FIG. 1, a pictorial representation of a data processing system in which the present invention may be implemented is depicted in accordance with a preferred embodiment of the present invention. A computer 100 is depicted which includes a system unit 110, a video display terminal 102, a keyboard 104, storage device 108, which may include floppy drives and other types of permanent and removable storage media, and mouse 106. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

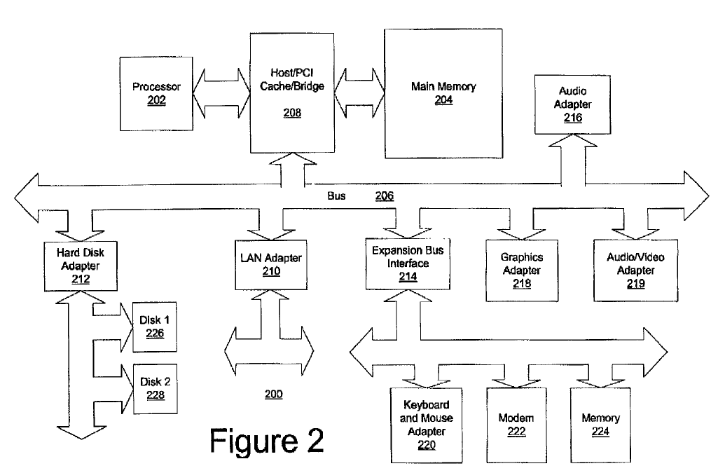

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. Hard Disk adapter 212 provides a connection for hard disk drives 226, 228. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system. Data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more hard disks 226, 228.

In accordance with a preferred embodiment of the present invention, a specialized hard disk adapter 212 or file system provides a Redundant Array of Independent Disks (RAID) subsystem using hard disks 226, 228.

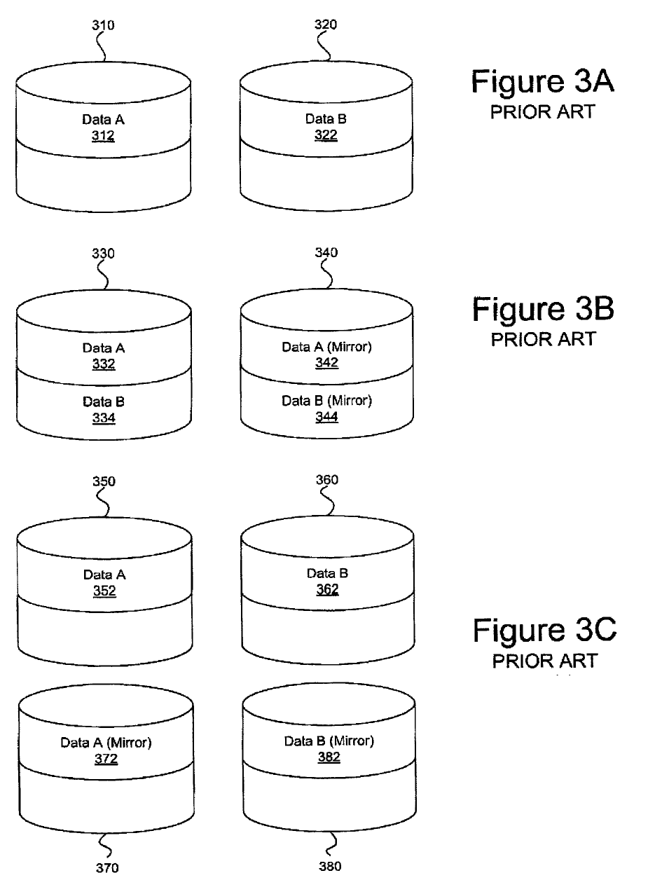

FIGS. 3A-3C are block diagrams illustrating prior art techniques for striping and mirroring data. Particularly, with reference to FIG. 3A, a block diagram illustrating data striping (RAID 0) is shown. When data is written, the data is divided into two stripes, data A and data B. Data A 312 may be written to hard disk 310 and data B 322 may be simultaneously written to hard disk 320. Data may also be divided into more stripes and written to more hard disks or written to hard disks 310, 320 in pairs. When data is read, data A may be read from hard disk 310 while data B is read from hard disk 320. Data striping allows more than one stripe to be written or read simultaneously, thus providing an increase in performance.

Turning now to FIG. 3B, a block diagram illustrating data mirroring (RAID 1) is shown. When data is written to hard disk 330, the data is simultaneously duplicated on hard disk 340. While data A 332 is written to hard disk 330, data A 342 is mirrored on hard disk 340. Similarly, while data B 334 is written to hard disk 330, data B 344 is written to hard disk 340. Data mirroring provides fault tolerance by duplicating the data on two drives. Validation may be performed when data is read. For example, when data B 334 is read from hard disk 330, data B 344 may be simultaneously read from hard disk 340. A comparison may be made to identify data corruption. A failed drive may be replaced with a new drive and a RAID controller can automatically rebuild the lost data.

With reference now to FIG. 3C, a block diagram is shown illustrating data striping and data mirroring used in conjunction (RAID 0/1). When data is written, the data is divided into two stripes, data A and data B. Data A 352 may be written to hard disk 350 and data B 362 may be simultaneously written to hard disk 360. Also, while data A 352 is written to hard disk 350, data A 372 is simultaneously mirrored on hard disk 370. Similarly, while data B 362 is written to hard disk 360, data B 384 is simultaneously written to hard disk 380.

Data striping allows stripes to be written to or read from hard disks 350, 360 simultaneously, thus providing an increase in performance. Data mirroring allows data to be validated by comparing stripes on hard disks 350, 360 with stripes on hard disks 370, 380. Using disk striping (RAID 0) and disk mirroring (RAID 1) in conjunction may provide the performance of striping and the reliability of mirroring.

However, using RAID 0 and RAID 1 in conjunction requires at least four disk drives, two drives for striping and two more drives to mirror the stripes. For example, hard disks 350, 360 may be twenty gigabyte (GB) hard disks. Thus, hard disks 370, 380 must also be twenty gigabyte hard disks. To use RAID 0/1, a computer must support four twenty gigabyte hard disks. Most small offices and home offices use general purpose personal computers. These computers typically have a maximum of two disk drives due to size and expense. The size may be constrained due to the available space inside the computer housing or the number of available drive bays. Most personal computers ship with two Integrated Drive Electronics (IDE) chanels (controllers) built into the motherboard. One channel is typically used for storage devices, such as compact disk drives, digital video disk drives, compressed media drives. The other channel is typically used for hard disk drives, usually one but as many as two drives. Furthermore, the cost of additional hard drives may inhibit the use of RAID 0/1. Therefore, one must decide between striping and mirroring when implementing RAID on a general purpose computer.

In accordance with a preferred embodiment of the present invention, a hard disk drive may be used to both mirror and stripe data. At the time of a write, a hard disk controller may write a first stripe to a first hard disk and allocate an appropriate amount of space on a second hard disk to mirror the stripe. Simultaneously, a second stripe may be written to the second hard disk and an appropriate amount of space may be allocated on the first hard disk to mirror the second stripe. Information about which stripes have and have not been mirrored is stored in memory. At a later time, such as during idle disk time, a controller or file system may synchronize the data between drives by copying the corresponding stripe into the pre-allocated space. During idle disk time, the controller or file system may also validate stripes to identify corrupted data. Data may also be validated at other times, such as system startup.

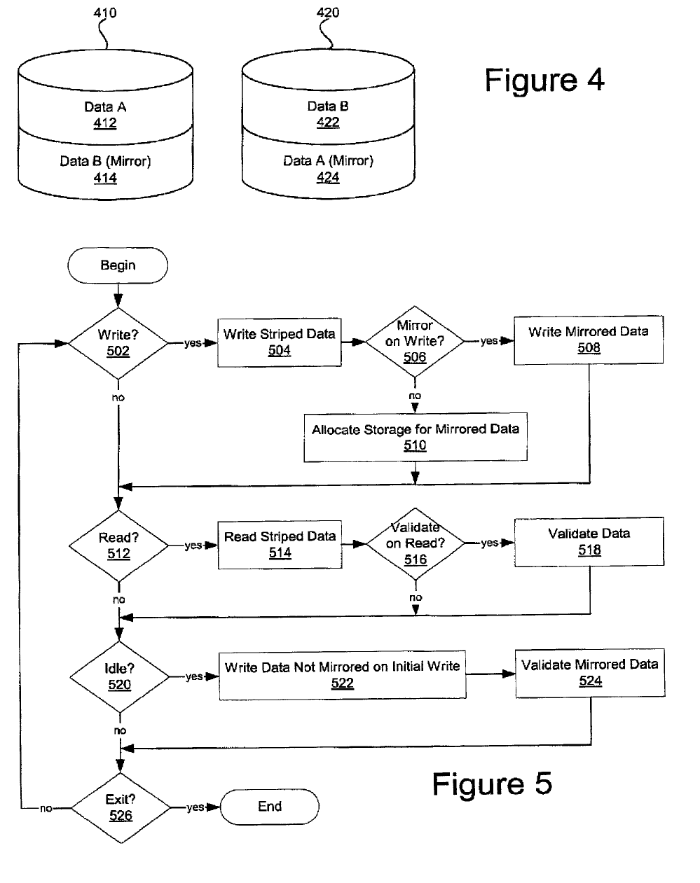

With reference to FIG. 4, a block diagram illustrating data striping and data mirroring used in conjunction is shown in accordance with a preferred embodiment of the present invention. At the time of a write, data A 412 is written to hard disk 410 and an appropriate amount of space is allocated on a hard disk 420 to mirror the stripe. Simultaneously, data B 422 is written to hard disk 420 and an appropriate amount of space is allocated on hard disk 410 to mirror the stripe. At a later time, the data between drives is synchronized by copying the data A 424 into the pre-allocated space on hard disk 420 and copying data B 414 into the pre-allocated space on hard disk 410.

Thus, one may realize the increased performance of striping and the increased reliability of mirroring without requiring four or more hard disk drives. Hard disks 410, 420 must support double the capacity required for striping or mirroring alone. However, there is no penalty with respect to size for doubling the capacity. For example, a forty gigabyte hard drive takes up the same amount of space as a twenty gigabyte hard drive. And doubling the capacity is inexpensive relative to the cost of doubling the number of drives. A forty gigabyte hard drive is less costly than two twenty gigabyte hard drives, for example.

In an alternative embodiment, a user may specify whether to mirror data at the time of a write and whether to validate data at the time of a read. Therefore, the user may decide between speed and reliability for both reads and writes. For example, a computer may be used primarily to store data. A user may then specify that the computer mirror data during idle disk time, but validate data at read time. Conversely, a computer may also be used to store data and repeatedly access the stored data. A user may then specify that the computer mirror the data at write time for reliability, but not validate data at read time, thus realizing increased speed in reading striped data.

With reference now to FIG. 5, a flowchart is shown illustrating the operation of a hard disk controller or file system in accordance with a preferred embodiment of the present invention. The process begins and a determination is made as to whether a write is to be performed (step 502). If data is to be written, the process writes the striped data (step 504) and a determination is made as to whether the RAID subsystem is configured to mirror at the time of write (step 506). If the subsystem is configured to mirror at write, the process writes the mirrored data (step 508) and a determination is made as to whether a read is to be performed (step 512).

If the subsystem is not configured to mirror at write in step 506, the process allocates storage for mirrored data (step 510) and proceeds to step 512 to determine whether a read is to be performed. Returning to step 502, if a write is not to be performed, the process proceeds to step 512 to determine whether a read is to be performed.

If data is to be read, the process reads the striped data (step 514) and a determination is made as to whether the RAID subsystem is configured to validate data at the time of read (step 516). If the subsystem is configured to validate data at read, the process validates the data if it has already been mirrored (step 518) and a determination is made as to whether the hard disk is idle (step 520).

If the subsystem is not configured to validate data at read in step 516, the process proceeds to step 520 to determine whether the hard disk is idle. Returning to step 512, if a read is not to be performed, the process proceeds to step 520 to determine whether the hard disk is idle.

If the hard disk is idle, the process writes data that has not been mirrored on initial write (step 522) and validates mirrored data (step 524). Thereafter, a determination is made as to whether an exit condition exists (step 526). An exit condition may exist, for example, upon a shutdown of the computer system or when a power management subsystem causes the hard disks to enter a “sleep” or dormant mode. If the hard disk is not idle in step 520, the process proceeds to step 526 to determine whether an exit condition exists. If an exit condition exists, the process ends. If an exit condition does not exist in step 526, the process returns to step 502 to determine whether data is to be written.

Thus, the present invention solves the disadvantages of the prior art by providing multiple types of RAID without increasing the number of required disk drives. The present invention stripes data and allocates an appropriate amount of space on a second hard disk to mirror the stripe. Information about which stripes have and have not been mirrored is stored in memory. At a later time, such as during idle disk time, a controller or file system may synchronize the data between drives by copying the corresponding stripe into the pre-allocated space. During idle disk time, the controller or file system may also validate stripes to identify corrupted data. Thus, one may realize the increased performance of striping and the increased reliability of mirroring without requiring four or more hard disk drives. A user may also specify whether to mirror data at the time of a write and whether to validate data at the time of a read. Therefore, the user may decide between speed and reliability for both reads and writes individually.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for storing data, comprising:
dividing data into at least a first stripe and a second stripe;
storing the first stripe in a first storage and simultaneously storing the second stripe in a second storage;
allocating space for the first stripe in the second storage and allocating space for the second stripe in the first storage; and
duplicating the first stripe in the space for the first stripe and duplicating the second stripe in the space for the second stripe.

2. The method of claim 1, further comprising:
validating the first stripe.

3. The method of claim 2, wherein the step of validating the first stripe comprises:
comparing the first stripe in the first storage with the duplicated first stripe in the second storage.

4. The method of claim 2, wherein the step of validating the first stripe is performed during idle disk time.

5. The method of claim 2, wherein the step of validating the first stripe is performed at startup.

6. The method of claim 1, wherein the step of duplicating the first stripe and duplicating the second stripe is performed during idle disk time.

7. A method for storing data, comprising:
dividing data into at least a first stripe and a second stripe;
storing the first stripe in a first storage and the second stripe in a second storage;
duplicating the first stripe in the second storage and duplicating the second stripe in the first storage; and
validating the first stripe.

8. The method of claim 7, wherein the step of duplicating the first stripe and duplicating the second stripe comprises:
allocating space for the first stripe in the second storage and allocating space for the second stripe in the first storage; and
copying the first stripe into the space for the first stripe and copying the second stripe into the space for the second stripe.

9. The method of claim 8, wherein the step of copying the first stripe and copying the second stripe is performed during idle disk time.

10. The method of claim 7, wherein the first stripe is duplicated in the second storage at the time of storing the first stripe in the first storage.

11. The method of claim 7, wherein the step of duplicating the first stripe and duplicating the second stripe is performed during idle disk time.

12. The method of claim 11, wherein the first stripe and the second stripe are duplicated simultaneously.

13. The method of claim 7, wherein the step of validating the first stripe is performed during idle disk time.

14. The method of claim 7, wherein the step of validating the first stripe is performed at a time of reading the first stripe.

15. The method of claim 7, wherein the step of validating the first stripe comprises:
comparing the first stripe in the first storage with the duplicated first stripe in the second storage.

16. An apparatus for storing data, comprising:
striping means for means for dividing data into at least a first stripe and a second stripe;
storage means for storing the first stripe in a first storage and simultaneously storing the second stripe in a second storage;
allocation means for allocating space for the first stripe in the second storage and allocating space for the second stripe in the first storage; and
duplication means for duplicating the first stripe in the space for the first stripe and duplicating the second stripe in the space for the second stripe.

17. The apparatus of claim 16, further comprising:
validation means for validating the first stripe.

18. The apparatus of claim 17, wherein the validation means comprises:
comparison means for comparing the first stripe in the first storage with the duplicated first stripe in the second storage.

19. The apparatus of claim 17, wherein the validation means comprises means for validating the first stripe during idle disk time.

20. The apparatus of claim 17, wherein the validation means comprises means for validating the first stripe at startup.

21. The apparatus of claim 16, wherein the duplication means comprises means for duplicating the first stripe and the second stripe during idle disk time.

22. An apparatus for storing data, comprising:
division means for dividing data into at least a first stripe and a second stripe;
storage means for storing the first stripe in a first storage and the second stripe in a second storage;
duplication means for duplicating the first stripe in the second storage and duplicating the second stripe in the first storage; and
validation means for validating the first stripe.

23. The apparatus of claim 22, wherein the duplication means comprises:
allocation means for allocating space for the first stripe in the second storage and allocating space for the second stripe in the first storage; and
copy means for copying the first stripe into the space for the first stripe and copying the second stripe into the space for the second stripe.

24. The apparatus of claim 23, wherein the copy means comprises means for copying the first stripe and the second stripe during idle disk time.

25. The apparatus of claim 22, wherein the first stripe is duplicated in the second storage at the time of storing the first stripe in the first storage.

26. The apparatus of claim 22, wherein the duplication means comprises means for duplicating the first stripe and the second stripe during idle disk time.

27. The apparatus of claim 26, wherein the first stripe and the second stripe are duplicated simultaneously.

28. The apparatus of claim 22, wherein the validation means comprises means for validating the first stripe during idle disk time.

29. The apparatus of claim 22, wherein the validation means comprises means for validating the first stripe at a time of reading the first stripe.

30. The apparatus of claim 22, wherein the validation means comprises:
comparison means for comparing the first stripe in the first storage with the duplicated first stripe in the second storage.

31. An apparatus for storing data, comprising:
a first storage;
a second storage; and
a controller that divides data into at least a first stripe and a second stripe, stores the first stripe in the first storage and simultaneously stores the second stripe in the second storage, allocates space for the first stripe in the second storage and allocating space for the second stripe in the first storage, and duplicates the first stripe in the space for the first stripe and the second stripe in the space for the second stripe.

32. An apparatus for storing data, comprising:
a first storage;
a second storage; and
a controller that divides data into at least a first stripe and a second stripe, stores the first stripe in a first storage and the second stripe in a second storage, duplicates the first stripe in the second storage and the second stripe in the first storage, and validates the first stripe.

33. A computer program product, in a computer readable medium, for storing data, comprising:
instructions for dividing data into at least a first stripe and a second stripe;
instructions for storing the first stripe in a first storage and simultaneously storing the second stripe in a second storage;
instructions for allocating space for the first stripe in the second storage and allocating space for the second stripe in the first storage; and
instructions for duplicating the first stripe in the space for the first stripe and duplicating the second stripe in the space for the second stripe.

34. A computer program product, in a computer readable medium, for storing data, comprising:
instructions for dividing data into at least a first stripe and a second stripe;
instructions for storing the first stripe in a first storage and the second stripe in a second storage;
instructions for duplicating the first stripe in the second storage and duplicating the second stripe in the first storage; and
instructions for validating the first stripe.
